(19) United States
(12) Patent Application Publication
(10) Pub. No.: US 2014/0139868 A1
(43) Pub. Date: May 22, 2014

(54) COMMUNICATION SYSTEM, COMMUNICATION APPARATUS AND COMMUNICATION METHOD

(71) Applicant: Taichi YOSHIOKA, Kanagawa (JP)

(72) Inventor: Taichi YOSHIOKA, Kanagawa (JP)

(73) Assignee: RICOH COMPANY, LTD., Tokyo (JP)

(21) Appl. No.: 14/049,524

(22) Filed: Oct. 9, 2013

(30) Foreign Application Priority Data
Nov. 19, 2012 (JP) 2012-252930

(51) Int. Cl. G06F 3/12

(52) U.S. Cl. CPC G06F 3/1221; G06F 3/1236
USPC 358/1.15

(57) ABSTRACT

A communication system includes a plurality of communication apparatuses and a host apparatus that is connected to the plurality of the communication apparatuses through a network. The plurality of the communication apparatuses includes a first communication apparatus and a second communication apparatus. The first communication apparatus obtains information about the second communication apparatus by using a second communication unit that performs communication with the second communication apparatus that has moved to a state in which the second communication apparatus cannot communicate through the network and reports to the host apparatus the obtained information about the second communication apparatus through a first communication unit that performs communication through the network. The host apparatus accepts a first command from a user for the second communication apparatus based on the information about the second communication apparatus reported by the first communication apparatus.

### BACKGROUND OF THE INVENTION

1. Field of the Invention

The disclosures herein generally relate to a communication system.

2. Description of the Related Art

In these years, there is an increasing request for reducing power consumption of MFP/LP (MultiFunction Peripheral/Line Printer) apparatuses. An MFP/LP apparatus stays in a standby mode (or energy saving mode) for a long time, and it is becoming important to reduce energy consumption during the standby mode. A large-scale office is equipped with more than one MFP/LP apparatus in accordance with the number of people working in the office, but not all of the apparatuses are always being used.

In order to reduce the power consumption during the standby mode, a method is known in which an MFP/LP-apparatus-unused time zone is set, during which MFP/LP apparatuses are not used, for example, a period of night time or a period of time when illumination intensity level of the location where the MFP/LP apparatuses are located is less than a predefined threshold value. During this time zone, the MFP/LP apparatuses move into a power consumption mode in which the power consumption is further less than that in a regular power consumption mode in which the MFP/LP apparatuses are still capable of responding through a network. In the power consumption mode in which the power consumption is less than that in the regular power consumption mode, the MFP/LP apparatuses are set to be incapable of responding through a network.

In an energy saving mode, in which network responses are disabled, a method is known in which AC power consumption is made zero by not using AC power, and by using a primary battery or a secondary battery.

Also, a technology for lowering power consumption is known which uses one of a printer server, a proxy server and one of plural MFP/LP apparatuses as a host apparatus that performs the MFP/LP power management and controls unnecessary MFP/LP apparatuses to move into a low power consumption mode.

A technology is known in which plural MFP/LP apparatuses are divided into a main apparatus and sub apparatuses, where the sub apparatuses are caused to be incapable of responding through a network depending on a usage situation of the MFP/LP apparatuses; and in the case where the usage situation changes, the main apparatus, by using a low power communication unit other than a network communication unit, causes the sub apparatuses to return to being capable of responding through the network.
[Patent Document 1] Japanese Patent Application Publication No. 2000-122953

### SUMMARY OF THE INVENTION

In a system in which a sub apparatus's communication-through-network function is disabled when the sub apparatus is set in a low energy consumption mode, even when a user wants to use the sub apparatus, whose communication-through-network function is disabled, for executing a print job, the user can only select the main apparatus.

Therefore, it is a general object of at least one embodiment of the present invention to cause a communication apparatus to execute a command when the communication apparatus is in a state of being incapable of communicating through network.

In one embodiment, a communication system includes a plurality of communication apparatuses and a host apparatus that is connected to the plurality of the communication apparatuses through a network. The plurality of the communication apparatuses includes a first communication apparatus as a main apparatus and a second communication apparatus as a sub apparatus. The first communication apparatus includes a first communication unit for communicating with the host apparatus through the network; a second communication unit for communicating with the second communication apparatus that has moved to a state of being incapable of communication through the network; and an apparatus information obtaining unit for obtaining information about the second communication apparatus that has moved to the state of being incapable of communicating through the network. The first communication unit reports to the host apparatus the information about the second communication apparatus obtained by the apparatus information obtaining unit, and the host apparatus accepts a first command from a user for the second communication apparatus based on the information about the second communication apparatus reported by the first communication apparatus.

According to an embodiment of the present invention, it is possible to cause the communication apparatus, which is in the state of being incapable of communicating through the network, to execute the command.

### BRIEF DESCRIPTION OF THE DRAWINGS

Other objects and further features of embodiments will become apparent from the following detailed description when read in conjunction with the accompanying drawings.

FIG. 1 is a drawing illustrating an embodiment of a communication system.

FIG. 2 is a drawing illustrating of a state transition of an image forming apparatus of the embodiment.

FIG. 3 is a drawing illustrating an image forming apparatus of the embodiment.

FIG. 4 is a functional block diagram illustrating the image forming apparatus of the embodiment.

FIG. 5 is a functional block diagram illustrating the image forming apparatus of the embodiment.

FIG. 6 is a drawing illustrating operations of the communication system of the embodiment.

FIG. 7 is a sequence chart illustrating operations of the communication system of the embodiment.

FIG. 8 is a drawing illustrating a GUI of a host apparatus of the embodiment.

FIG. 9 is a drawing illustrating operations of a communication system of a modified embodiment.

FIG. 10 is a sequence chart illustrating an modified embodiment of operations of the communication system.

FIG. 11 is a sequence chart illustrating operations of a communication system of a modified embodiment.

FIG. 12 is a drawing illustrating an image forming apparatus of the modified embodiment.

FIG. 13 is a drawing illustrating a GUI of a host apparatus of the modified embodiment.

### DESCRIPTION OF THE PREFERRED EMBODIMENTS

In the following, embodiments of the present invention will be described with reference to the accompanying drawings.

Note that the same referral numbers are used throughout the figures when referring to the same functions, and repeated descriptions of the functions are omitted.

### EMBODIMENTS

### Communication System

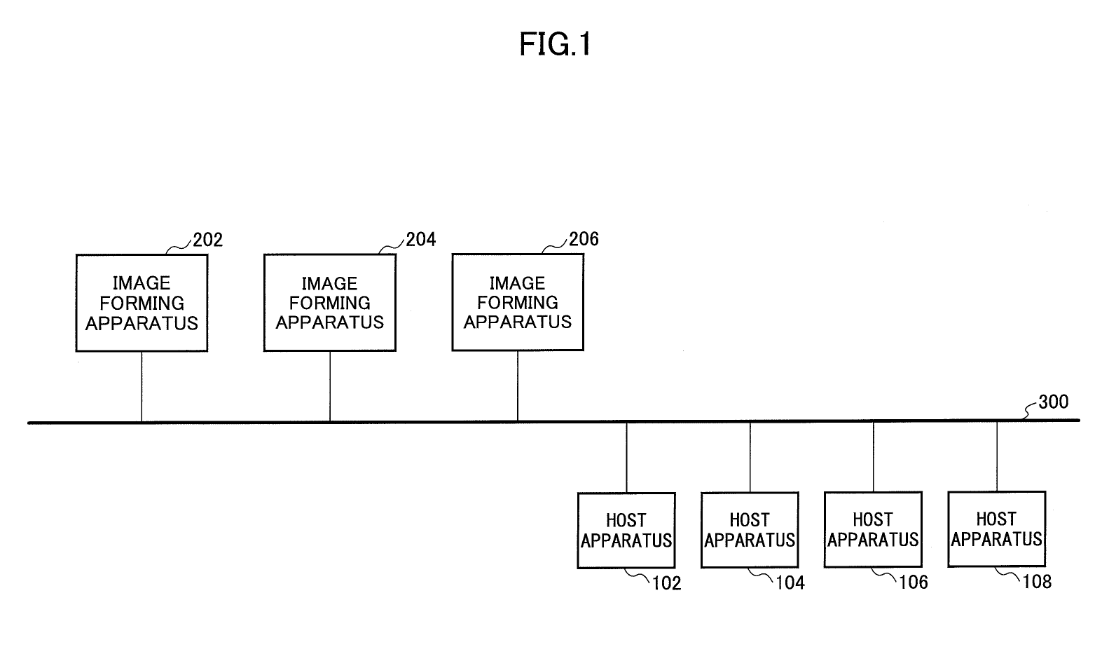

FIG. 1 shows an embodiment of a communication system.

The communication system includes a plurality of image forming apparatuses and one or more host apparatuses. The image forming apparatus may be called a communication apparatus. In FIG. 1, as an example, four host apparatuses 102, 104, 106 and 108, and three image forming apparatuses 202, 204 and 206 are shown. There may be one through three host apparatuses or more than four host apparatuses. There may be one or two image forming apparatuses or more than three image forming apparatuses.

The plurality of the image forming apparatuses 202, 204 and 206 is connected to a network 300 such as an Ethernet (registered trade mark). Also, the host apparatuses 102, 104, 106 and 108 are connected to the network 300. The host apparatuses 102, 104, 106 and 108 can be configured to be PCs, etc. The host apparatuses 102, 104, 106 and 108 transmit commands such as a print job to the image forming apparatuses 202, 204 and 206 through the network 300.

The image forming apparatuses 202, 204 and 206 include a first communication unit for communicating with the host apparatuses 102, 104, 106 and 108 through the network 300. Also, the image forming apparatuses 202, 204 and 206 include a second communication unit for communicating with other image forming apparatuses without using the network 300.

It is assumed that of the image forming apparatuses 202, 204 and 206, the image forming apparatus 202 is a main apparatus, and the image forming apparatuses 204 and 206 are sub apparatuses. For example, during the energy saving state, a function of communicating through the network 300 (hereinafter called a “responding-through-network function”) of sub-apparatus image forming apparatuses 204 and 206, is disabled. The responding-through-network function of the main-apparatus image forming apparatus 202, is not disabled even during the energy saving state. Also, the main-apparatus image forming apparatus 202 activates the second communication unit as necessary during the energy saving state. The sub-apparatus image forming apparatuses 204 and 206, activate the second communication unit when they move into the energy saving state.

<The Second Communication Unit>

Regarding the second communication unit, it is normally deactivated, and it is preferable that it is activated as necessary. Unnecessary energy can be saved during a normal state by activating the second communication unit as necessary.

The image forming apparatuses 204 and 206 activate their second communication units when they move to a shutdown mode in accordance with a command for moving to the shutdown mode transmitted to them by the image forming apparatus 202 through the network 300.

The image forming apparatus 202, after transmitting a command for moving to the shutdown mode to the image forming apparatuses 204 and 206, activates the second communication unit in the case where it becomes necessary to communicate with the image forming apparatuses 204 and 206.

Using the second communication unit, a command for returning to a standby mode, information that reports status of the apparatuses, etc., are exchanged among the apparatuses. A high speed transmission or a wide bandwidth is not required for the second communication unit. Therefore, a low-power-consumption communication unit or a low-cost communication unit can be used as the second communication unit.

Wired communication, infrared communication, optical communication, etc., may be used for the second communication unit. Also, near field communication technologies such as Zigbee (registered trade mark), Bluetooth (registered trade mark), etc., may be used for the second communication unit. By using the near field communication technologies, low energy consumption can be realized.

For example, in the case where the wired communication is used for the second communication unit, the image forming apparatuses are connected by cables. Among the apparatuses, a serial communication by a UART (Universal Asynchronous Receiver Transmitter), etc., included in the second communication unit may be performed. It is preferable that the image forming apparatuses are connected by using the daisy chain connection. The reason is that if the main-apparatus image forming apparatus 202 is connected to the plural sub-apparatus image forming apparatuses 204 and 206 by using the star connection, then the main image forming apparatus must be able to connect as many cables as the number of the sub image forming apparatuses, which increases the number of connection ports and increases the length of the cable.

Also, in the case where the infrared communication or the optical communication is used for the second communication unit, it is necessary that the main image forming apparatus 202 and the sub image forming apparatuses 204 and 206 are to be placed within a range of the infrared signal of the second communication unit.

Also, in the case where the near field communication technology is used for the second communication unit, a battery-powered operation may be possible because of the very low energy consumption. Because the wireless communication can cover an office space as big as a whole building floor, the restrictions for the locations of the image forming apparatuses are not so many.

The image forming apparatus 202 monitors an amount of print jobs of the image forming apparatuses 204 and 206 and estimates the amount of print jobs. Various methods can be used for estimating the print jobs. The image forming apparatus 202 determines whether it is required that all of the image forming apparatuses activate the responding-through-network function or not based on the estimated print jobs.

In the case where it determines that it is not required that all of the image forming apparatuses activate the responding-through-network function, the image forming apparatus 202 selects image forming apparatuses that do not need to activate the responding-through-network function. The image forming apparatus 202 transmits via the network 300 the command for moving to the shutdown mode to the sub-apparatus image forming apparatuses, which are going to deactivate the responding-through-network function.

Even in the case where the amount of print jobs are low, it is preferable not to cause the image forming apparatus currently being used to move to the shutdown mode. Therefore, it is preferable for the image forming apparatus 202 to know the operational state of the image forming apparatuses 204 and 206 before determining whether to transmit a command for moving to the shutdown mode. Or the image forming apparatus 202 may transmit the command for moving to the shutdown mode without knowing the state of the image forming apparatuses 204 and 206, and the image forming apparatuses 204 and 206 that receive the command may move to the shutdown mode only after they become ready to move to the shutdown mode.

The image forming apparatus 202, in the case where the responding-through-network function of the image forming apparatuses 204 and 206 is not activated, activates the second communication unit as necessary. The image forming apparatus 202 obtains information about the image forming apparatus 204 and 206 from the image forming apparatuses 204 and 206 by using the second communication unit. The information about the image forming apparatuses 204 and 206 includes a model number, a remaining amount of the toner, a remaining battery amount, etc.

The image forming apparatuses, whose responding-through-network function is not activated, cannot be recognized by the host apparatuses 102, 104, 106 and 108. However, the image forming apparatus 202 transmits the information about the image forming apparatuses 204 and 206 to the host apparatuses 102, 104, 106 and 108; and a printer driver installed in each of the host apparatuses 102, 104, 106 and 108 interprets the information about the image forming apparatuses 204 and 206. And the host apparatuses 102, 104, 106 and 108 can recognize the existence of the image forming apparatuses whose responding-through-network function is not activated.

The host apparatuses 102, 104, 106 and 108 can transmit a command for returning to the standby mode or a command of a print job to the image forming apparatuses 204 and 206, whose responding-through-network function is not activated, via the image forming apparatus 202 as a main apparatus, whose responding-through-network function is activated. That is, a user, without going to the place where the image forming apparatuses 204 and 206, whose responding-through-network function is not activated, are placed, can cause them to return to the standby mode and use them in the usual manner.

Also, the image forming apparatus that serves as the main apparatus and the image forming apparatuses that serve as the sub apparatuses are not needed to be fixedly selected. It is possible that the sub apparatuses and the main apparatus are switched in accordance with the situation.

<States of the Image Forming Apparatus>

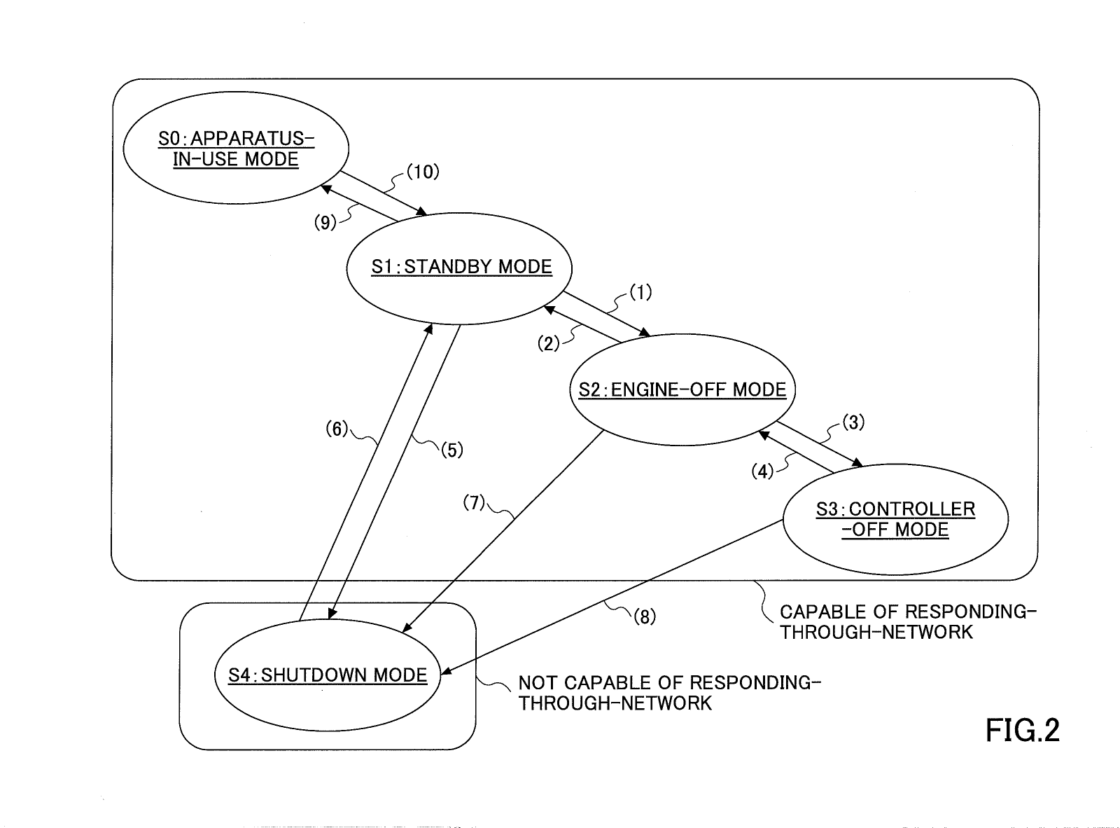

FIG. 2 is a drawing illustrating an embodiment of a state transition of the image forming apparatus. The image forming apparatuses 202, 204 and 206 include five states of an apparatus-in-use mode (S0), a standby mode (S1), an engine-off mode (S2), a controller-off mode (S3), and a shutdown mode (S4).

Each of the states will be described.

The apparatus-in-use mode (S0) is a state in which a job as a scanner, a printer, a copier, etc. is being processed.

The standby mode (S1) is a state in which an apparatus is powered and ready for use.

The engine-off mode (S2) is a state in which an engine part is not powered. The energy consumption in S2 can be made lower than S1.

The controller-off mode (S3) is a state in which a controller CPU or a controller ASIC (Application Specific Integrated Circuit) is not powered. The responding-through-network function is activated in S3 and a sub SoC (System-On-a-Chip) is powered. Therefore, a print job from the host apparatus can be handled in S3 state.

The shutdown mode (S4) is a mode in which all parts of the apparatus are not powered except for a microcomputer of an operation part, an illumination sensor, a restoration-triggering hard key, a status-report LED and the second communication unit. The sub SoC of the controller is not powered in S4 state. Therefore, a print job from the host apparatus cannot be handled in S4 state. The host apparatuses 102, 104, 106 and 108 that are connected to the network 300 cannot “see” an image forming apparatus in S4 state. The S4 is a state in which the energy consumption is the lowest. When an image forming apparatus is not used as in the night time, the energy consumption of the image forming apparatus can be lowered by moving to the shutdown mode.

The energy consumption will be discussed.

Regarding the energy consumption, the standby mode (S1)>the engine-off mode (S2)>the controller-off mode (S3)>the shutdown mode (S4).

Conditions for state transitions will be described.

The state moves from the standby mode (S1) to the engine-off mode (S2) by a key operation for moving-to-sleep-mode, etc., by a user or by an auto-transition by a timer ((1) in FIG. 2).

The state moves from the engine-off mode (S2) to the controller-off mode (S3) by an auto-transition by a timer ((3) in FIG. 2).

The state moves from the engine-off mode (S2) to the standby mode (S1) or from the controller-off mode (S3) to the engine-off mode (S2) in the case where a restoration cause is detected ((2) and (4) in FIG. 2). The restoration cause includes “opening/closing of a pressurizing plate”, “DF (Document Feeder) original set”, “receiving of a print job from a host apparatus”, etc.

The state moves from the standby mode (S1) to the shutdown mode (S4) in the case where the darkening is detected by the illumination sensor, etc., in the case where a user performs an operation for moving to the shutdown mode, in the case where a predefined time arrives, or in the case where a request is received from the image forming apparatus 202 for moving to the shutdown mode ((5) in FIG. 2). But even in the case where a request is received from the image forming apparatus 202 for moving to the shutdown mode, if it is the case where the apparatus is performing the printing operation or the apparatus is being operated by a user, then the state does not move to the shutdown mode.

The state moves from the engine-off mode (S2) to the shutdown mode (S4) or from the controller-off mode (S3) to the shutdown mode (S4) in the case where the darkening is detected by the illumination sensor, etc., or a predefined time arrives ((7) or (8) in FIG. 2).

The state moves from the standby mode (S1) to the apparatus-in-use mode (S0) at the start-up of a scanner job operation, a printer job operation, a copier job operation, etc. ((9) in FIG. 2).

The state moves from the apparatus-in-use mode (S0) to the standby mode (S1) at the end of the scanner job operation, the printer job operation, the copier job operation, etc ((10) in FIG. 2).

The state is moved from the engine-off state (S2) to the shutdown mode (S4) or from the controller-off mode (S3) to the shutdown mode (S4) by the image forming apparatuses 204 and 206.

The second communication unit is connected to a microcomputer that operates in any state of S1 through S4. The image forming apparatus 202 monitors the current amount of print jobs and estimates the amount of print jobs. The image forming apparatus 202 determines whether it is necessary or not to cause the responding-through-network function of the image forming apparatuses 204 and 206 to be activated based on the estimated amount of the print jobs. In the case where the image forming apparatus 202 determines that it is not necessary to cause the responding-through-network function of the image forming apparatuses 204 and 206 to be activated, the image forming apparatus 202 transmits a command for moving to the shutdown mode (S4) to the image forming apparatuses 204 and 206 via the network 300. The image forming apparatuses 204 and 206, upon receiving the command for moving to the shutdown mode (S4), activate the second communication unit and stop the power supply for the first communication unit for communicating via the network 300.

<Image Forming Apparatus>

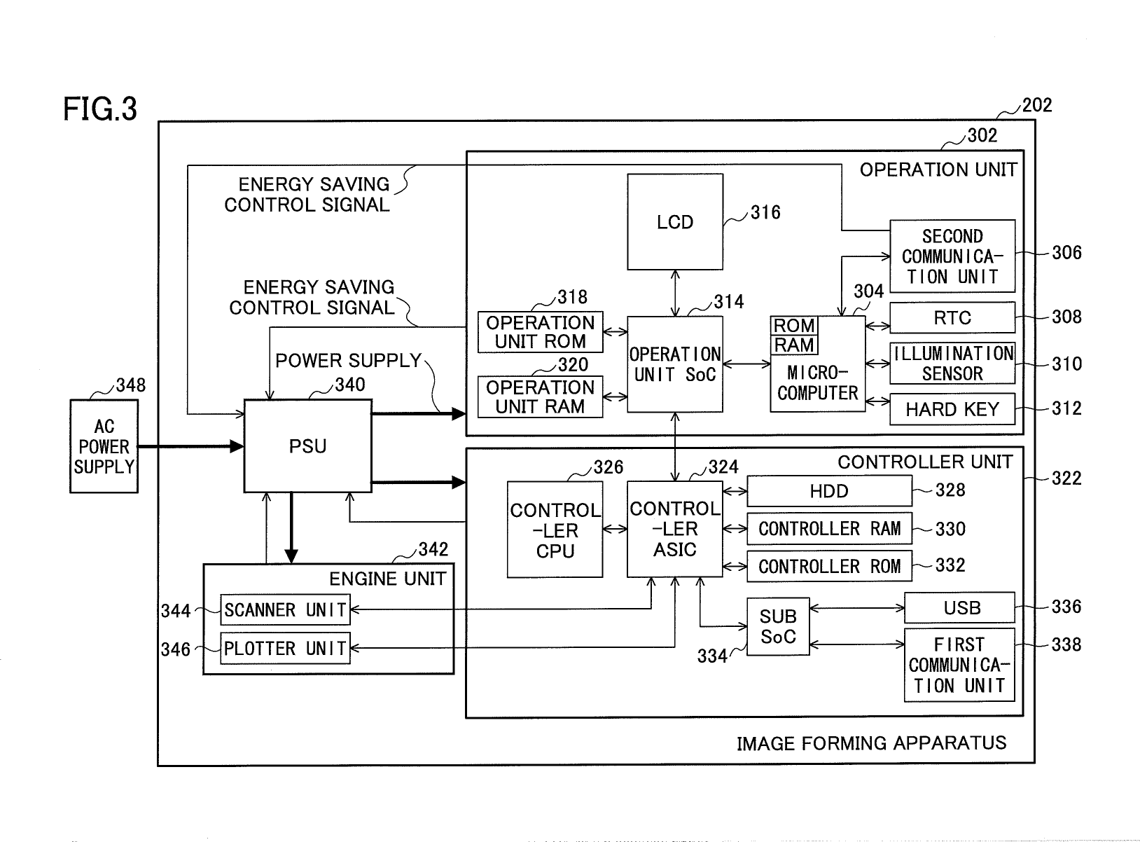

FIG. 3 shows an embodiment of the image forming apparatus 202. FIG. 3 mainly shows a hardware configuration of the image forming apparatus 202.

Configurations of the image forming apparatuses 204 and 206 are mostly the same as shown in FIG. 3. The second communication unit 306, however, may be different. For example, as the second communication unit, a wired communication unit, an infrared communication unit or a near field wireless communication unit may be used.

The image forming apparatus includes an operation unit 302, a controller unit 322, a PSU (Power Supply Unit) 340 and an engine unit 342. For the image forming apparatus 202, power is supplied to the PSU 340 from an AC power supply 348.

The operation unit 302 assumes a user interface role of the image forming apparatus 202. The operation unit 302 includes a microcomputer 304, the second communication unit 306, an RTC (Real-Time Clock) 308, an illumination sensor 310, a hard key 312, an operation unit SoC 314, an LCD (Liquid Crystal Display) 316, an operation unit ROM 318 and an operation unit RAM 320.

There are a built-in ROM and a built-in RAM in the microcomputer 304. The microcomputer 304 determines whether it moves to an energy saving mode or not by monitoring the illumination sensor 310, the hard key 312, the RTC 308, etc. Also, the microcomputer 304 determines, after it moves to the energy saving mode, whether it moves back to a normal mode or not. Also, the microcomputer 304 controls a PWM (Pulse Width Modulation) of an LED.

The second communication unit 306 is used in a state where the responding-through-network function is not activated. The second communication unit 306 is used for the command for returning to the standby mode (S1) from the shutdown mode (S4) or for reporting the apparatus's state.

The RTC 308 counts time.

The illumination sensor 310 detects luminance.

The hard key is a key for a user to operate the image forming apparatus 202.

The operation unit SoC 314 performs overall control of the operation unit 302.

The LCD 316 displays screens.

The operation unit ROM 318 is a ROM used by the operation unit SoC 314.

The operation unit RAM 320 is a RAM used by the operation unit SoC 314.

The controller unit 322 performs overall control of the image forming apparatus 202. The controller unit 322 includes a controller ASIC 324, a controller CPU 326, an HDD (Hard Disk Drive) 328, a controller RAM 330, a controller ROM 332, a sub SoC 334, a USB (Universal Serial Bus) 336 and a first communication unit 338 such as Ethernet (registered trade mark).

The controller ASIC 324 performs a process of compression, expansion, rotation, and editing for an image transmitted by a scanner unit 344. Also, the controller ASIC 324 controls the controller RAM 330, the controller ROM 332 and the HDD 328.

The controller CPU 326 performs overall control of the controller unit 322 and a process of drawing print data transmitted from the host apparatuses 102, 104, 106 and 108.

The HDD 328 stores data such as image data, back-up data for a paper jam, and other apparatus data.

The controller RAM 330 is a work memory for the controller CPU 326 and the controller ASIC 324.

The controller ROM 332 is a ROM for the controller CPU 326.

The sub SoC 334 performs input/output control of the USB 336 and the first communication unit 338. To be more precise, the sub SoC 334 causes the power of the controller ASIC 324 and the controller CPU 326 to be OFF when the state moves to the energy saving mode. The sub SoC 334, after the state moves to the energy saving mode, monitors the network 300 and responds to a packet from the first communication unit 338.

The USB 336 is a USB interface.

The first communication unit 338 is an interface. The image forming apparatus 202 is connected to the host apparatuses 102, 104, 106 and 108 via the first communication unit 338.

The PSU 340 provides power to the operation unit 302, the controller unit 322 and the engine unit 342.

The engine unit 342 performs reading an original, printing, etc. The engine unit 342 includes a scanner unit 344 and a plotter unit 346.

The scanner unit 344 reads the original as RGB digital image data by solid-state image sensing device such as a CCD (Charge Coupled Device image sensor), etc. The scanner unit 344 performs image processing such as shading correction, background removal, fixed-length coding, etc.

The plotter unit 346 prints an image processed by the scanner unit 344 or an image processed by the controller unit 322.

In the shutdown mode (S4), the power for the engine unit 342 and the controller unit 322 are caused to be OFF. In the shutdown mode (S4), regarding the operation unit 302, the power is caused to be OFF except for the microcomputer 304, the illumination sensor 310, the second communication unit 306 and the hard key 312. Also, it is preferable to keep the power for a status-report LED (Light Emitting Diode)(not shown in the figures) ON. To be more precise, in the shutdown mode (S4), the power for the LCD 316, the operation unit SoC 314, the operation ROM 318, the operation unit RAM 320 and the RTC 308 is caused to be OFF. Regarding the hard key 312, it is preferable to keep a part of the hard key 312 that triggers the state to move from the shutdown mode (S4) to the standby mode (S1) to be ON and to cause the remaining part of the hard key 312 to be OFF. In the shutdown mode (S4), the responding-through-network function is caused to be deactivated. As a result, the apparatus operates in a very low energy consumption mode and it can operate with power supplied by a power supply other than the AC power supply 348. The power supply other than the AC power supply 348 includes a battery cell or a power generating unit.

<Functions of the Image Forming Apparatus 202>

An embodiment of functions of the image forming apparatus 202 will be described.

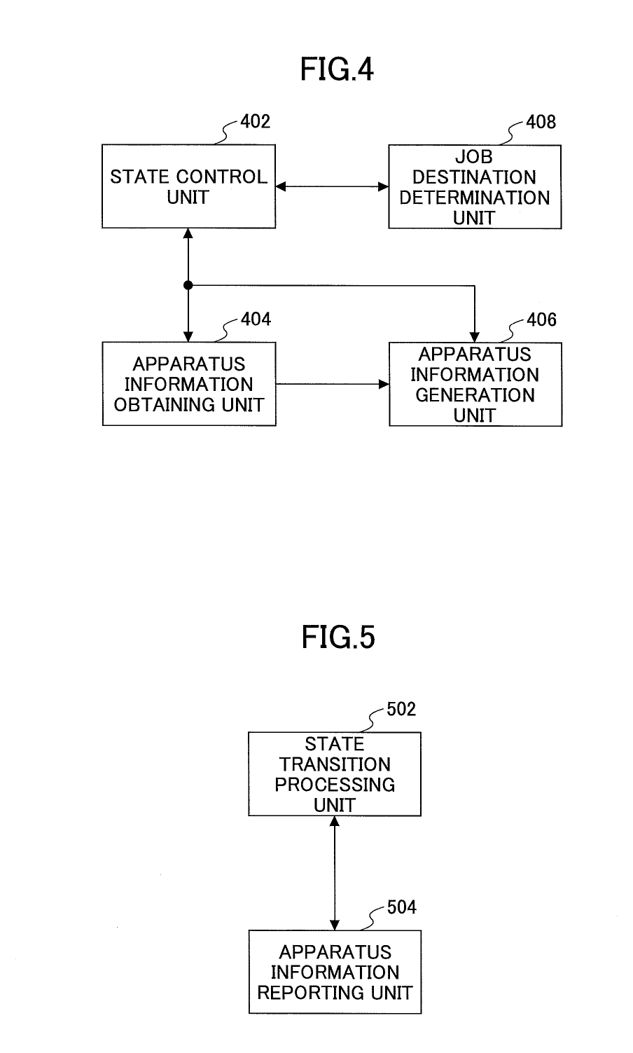

FIG. 4 is a functional block diagram illustrating an embodiment of a function of the image forming apparatus 202. The function indicated by this functional block diagram is mainly performed by the controller CPU 326 of the image forming apparatus 202. The function can be also performed by the controller CPU 326 of the image forming apparatuses 204 and 206.

The controller CPU 326 functions as a state control unit 402, an apparatus information obtaining unit 404, an apparatus information generation unit 406 and a job destination determination unit 408.

The state control unit 402 controls the state of the image forming apparatuses 204 and 206. For example, the state control unit 402 monitors an amount of print jobs of the image forming apparatuses 204 and 206. The state control unit 402 estimates the amount of print jobs of the image forming apparatuses 204 and 206 based on the monitored amount of print jobs. The state control unit 402 determines whether to cause the responding-through-network function of the image forming apparatuses 204 and 206 to be ON or not based on the estimated amount of print jobs. The state control unit 402 transmits a command for moving to the shutdown mode to the image forming apparatus the responding-through-network function of which is determined to be caused to be OFF. The state control unit 402 may transmit the command for moving to the shutdown mode to the sub-apparatus image forming apparatus, the responding-through-network function of which is determined to be caused to be OFF and which is also determined not to be currently in operation.

The apparatus information obtaining unit 404 is connected to the state control unit 402. The apparatus information obtaining unit 404 obtains information about the image forming apparatus that has moved to the state in which the responding-through-network function is OFF. For example, the apparatus information obtaining unit 404 obtains the information about the image forming apparatus that has moved to the state in which the responding-through-network function is OFF via the second communication unit 306. It is preferable that the information about the image forming apparatus include a model number of the apparatus, a remaining amount of toner, remaining battery power, etc.

The apparatus information generation unit 406 is connected to the state control unit 402 and the apparatus information obtaining unit 404. The apparatus information generation unit 406 generates information about the image forming apparatus whose responding-through-network function is OFF. The apparatus information generation unit 406 reports to the host apparatuses 102, 104, 106 and 108 the information about the image forming apparatus whose responding-through-network function is OFF.

The job destination determination unit 408 is connected to the state control unit 402. The job destination determination unit 408 determines whether a destination of a print job command from the host apparatuses 102, 104, 106 and 108 is the apparatus of the job destination determination unit 408 itself or not. The job destination determination unit 408, in the case where it determines that the destination of the print job is the apparatus itself, instructs the engine unit 342 to perform the print job via the controller ASIC 324. The job destination determination unit 408, in the case where it determines that the destination of the print job is not the apparatus itself, reports the same to the state control unit 402.

The state control unit 402, to which it is reported by the job destination determination unit 408 that the destination of the print job is not the apparatus itself, activates the second communication unit 306. The state control unit 402 generates a command for moving back to the standby mode (S1). The state control unit 402 transmits the command for moving back to the standby mode (S1) to the image forming apparatus, to which the print job command is destined, via the second communication unit 306.

### <Function of the Image Forming Apparatus 204>

An example of the function of the image forming apparatus 204 will be described.

FIG. 5 is a functional block diagram illustrating an embodiment of the function of the image forming apparatus 204. The function illustrated by this functional block diagram is mainly performed by the controller CPU 326 of the image forming apparatus 204. The function of the image forming apparatus 206 is almost the same as the image forming apparatus 204.

The controller CPU 326 functions as a state transition processing unit 502 and an apparatus information reporting unit 504.

The state transition processing unit 502 controls the state of the apparatus itself. For example, the state transition processing unit 502 performs the control of moving to the shutdown mode (S4) in accordance with the command from the image forming apparatus 202 for moving to the shutdown mode (S4). Also, the state transition processing unit 502 performs the control of moving to the standby mode (S1) in accordance with the command from the image forming apparatus 202 for moving back to the standby mode (S1).

The apparatus information reporting unit 504 is connected to the state transition processing unit 502. The apparatus information reporting unit 504, in the case where the responding-through-network function of its own apparatus is OFF, reports information about its own apparatus to the image forming apparatus 202. For example, the apparatus information reporting unit 504 reports the information about its own apparatus to the image forming apparatus 202 via the second communication unit 306. It is preferable that the information about the image forming apparatus include a model number of the apparatus, a remaining amount of toner, remaining battery power, etc.

<Operation of a Communication System>

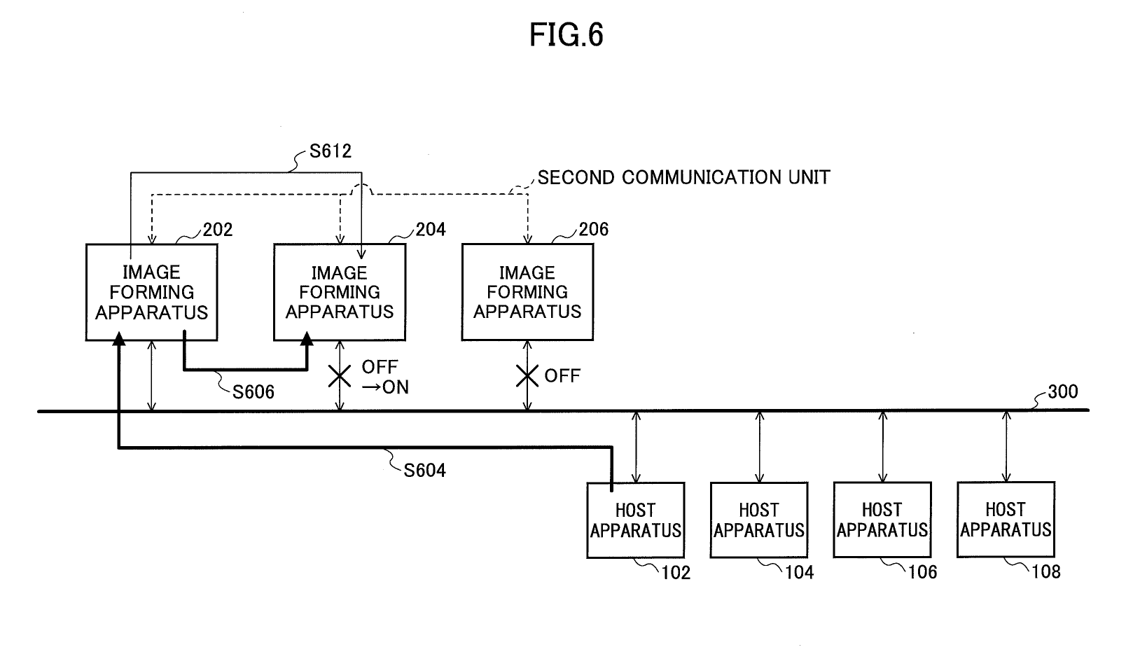

FIG. 6 shows an embodiment of an operation of a communication system. FIG. 6 shows the image forming apparatuses 202, 204 and 206 and the host apparatuses 102, 104, 106 and 108.

The image forming apparatuses 204 and 206 are in the shutdown mode (S4).

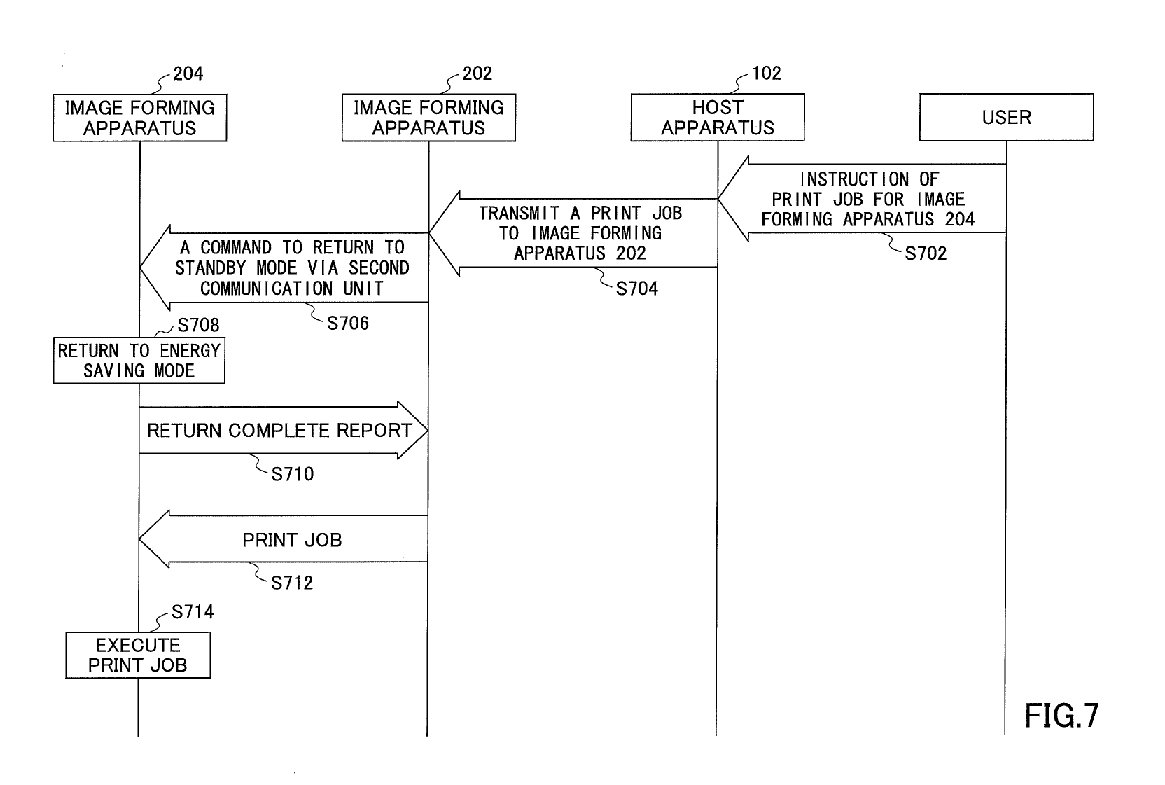

FIG. 7 is a sequence chart illustrating an embodiment of the operation of the communication system.

FIG. 7 shows an operation in a case where a print job is performed by using the image forming apparatus 204 whose responding-through-network function is OFF.

Steps of S604, S606 and S612 shown in FIG. 6 correspond to steps of S704, S706 and S712 shown in FIG. 7, respectively.

The image forming apparatuses 204 and 206, whose responding-through-network functions are OFF, report information about themselves to the image forming apparatus 202. The image forming apparatus 202 transmits the information reported by the image forming apparatuses 204 and 206 to the host apparatuses 102, 104, 106 and 108. In the host apparatuses 102, 104, 106 and 108, an installed printer driver interprets the information about the image forming apparatuses 204 and 206. The host apparatuses 102, 104, 106 and 108 recognize the existence of the image forming apparatuses 204 and 206 whose responding-through-network functions are OFF.

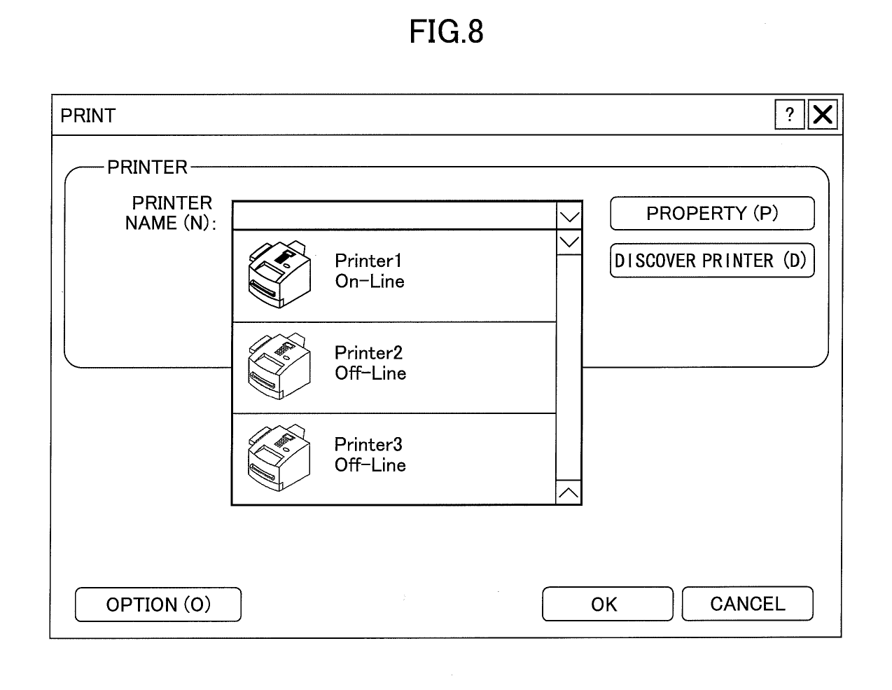

FIG. 8 shows an embodiment of a GUI (Graphical User Interface) that is shown by the host apparatuses 102, 104, 106 and 108 when an image forming apparatus is selected for printing.

In FIG. 8, three image forming apparatuses are shown. In FIG. 8, “Printer1” indicates the image forming apparatus 202, “Printer2” indicates the image forming apparatus 204 and “Printer3” indicates the image forming apparatus 206.

In the embodiment of the communication system, the responding-through-network functions of the image forming apparatuses 204 and 206 are OFF.

By running the printer driver, the image forming apparatuses 202, 204 and 206 are shown in the GUI of the host apparatuses 102, 104, 106 and 108. The image forming apparatuses 204 and 206 are displayed in such a way that it is indicated that their responding-through-network functions are OFF. In an example shown in FIG. 8, regarding the image forming apparatus, whose responding-through-network function is ON, “ON-Line” is shown, and regarding the image forming apparatuses 204 and 206, whose responding-through-network functions are OFF, “OFF-Line” is shown. Furthermore, pictures of the image forming apparatuses 204 and 206, whose responding-through-network functions are OFF, are grayed out, or drawn with pale gray color. The pictures of the image forming apparatuses may be drawn in the same way regardless whether their responding-through-network function are ON or OFF.

A user can perform printing by using any of “Printer1”, “Printer2” and “Printer3”.

In the case where the image forming apparatus 204 or 206 is selected by the user, the printing is performed after the responding-through-network function of the selected image forming apparatus is returned to ON.

From the energy saving viewpoint, it is not a preferable case that the image forming apparatus 204 or 206 is selected by the user. The reason is that it leads to causing the responding-through-network function to be ON. In this case, a GUI may be displayed that asks the user whether or not the user wants to cause the responding-through-network function to be ON.

In step S702 in FIG. 7, a user requests a print job. For example, in the case where the user wants the image forming apparatus 204 to do the print job, the user selects “Printer2” by using the GUI shown in FIG. 8. The print job instruction is input to the host apparatus 102 by the user's operation.

In step S704, the host apparatus 102, to which the print job instruction is input by the user, transmits the print job to the image forming apparatus 202. The print job includes flag information that indicates the image forming apparatus to execute the print job. The image forming apparatus 202 determines whether the print job is for the image forming apparatus 202 or for another image forming apparatus based on the flag information included in the print job. Here, the image forming apparatus 202 determines that the print job is for the other image forming apparatus 204.

In step S706, the image forming apparatus 202 transmits a command for returning to the standby mode (S1) to the image forming apparatus 204 via the second communication unit 306.

In step S708, the image forming apparatus 204, which receives the command for returning to the standby mode (S1) from the image forming apparatus 202, moves from the shutdown mode (S4) to the standby mode (S1).

In step S710, the image forming apparatus 204, after moving to the standby mode (S1), transmits a completion report of returning to the standby mode (S1) to the image forming apparatus 202.

In step S712, the image forming apparatus 202, which receives the completion report of returning to the standby mode (S1) from the image forming apparatus 204, turns over the print job to the image forming apparatus 204. The main-apparatus image forming apparatus 202 may turn over the print job via the network 300, or turn over the print job via the second communication unit 306. From the viewpoint of shortening the time for the printing, it is preferable that the print job is turned over via the network 300. The reason is that, when turning over the print job, the communication speed of the first communication unit 338 via the network 300 is faster than the communication speed of the second communication unit 306.

In step S714, the image forming apparatus 204 executes the print job from the image forming apparatus 202.

According to the present embodiment of the communication system, in an environment where multiple image forming apparatuses are placed and connected through a network, the responding-through-network functions can be set either ON or OFF in accordance with the situation of how each of the image forming apparatuses is used. Because the responding-through-network function can be set either ON or OFF for each of the image forming apparatuses, the power that is necessary for communication through the network can be reduced. Furthermore, the main-apparatus image forming apparatus reports to the host apparatuses information about the image forming apparatuses whose responding-through-network functions are OFF. With the information about the image forming apparatuses whose responding-through-network functions are OFF being reported by the main-apparatus image forming apparatus, the host apparatuses can recognize the image forming apparatuses whose responding-through-network functions are OFF. Furthermore, the host apparatuses can transmit a command to the image forming apparatuses whose responding-through-network functions are OFF.

Also, upon receiving the command from the host apparatuses for an image forming apparatus whose responding-through-network functions is OFF, the main-apparatus image forming apparatus can cause the image forming apparatus whose responding-through-network function is OFF to return to the standby mode (S1), and cause it to execute the command.

Conventionally, in a system in which responding-through-network functions of sub apparatuses are caused to be OFF, when a user performs a print job while the responding-through-network functions of sub apparatuses are OFF, the user can only select the main apparatus. In the embodiment of the communication system, the user can select a sub apparatus in addition to a main apparatus. Therefore, improved convenience is achieved because the sub apparatus, whose responding-through-network function is OFF, can be used in the case where there are differences in functionality or performance between the main apparatus and the sub apparatus, or in the case where the main apparatus and the sub apparatus are not placed in one location.

The present embodiment of the communication system can provide both the energy saving effect from causing the responding-through-network functions of the sub apparatuses to be OFF and the user convenience.

Also, conventionally, in a system in which power management of MFP/LP apparatuses is performed by using a proxy server, MFP/LP apparatuses return to the standby mode at the timing when they are operated by a user. In the present embodiment of the communication system, the apparatuses can return to the standby mode without the user operation. Time for waiting for a print job completion can be reduced because the print job execution does not require a user operation of causing the apparatus to return to the standby mode.

### Modified Embodiment (No. 1)

A modified embodiment of the communication system is about the same as the above embodiment.

The modified embodiment of the image forming apparatuses 202, 204 and 206 are about the same as the above embodiment.

<Operation of the Communication System>

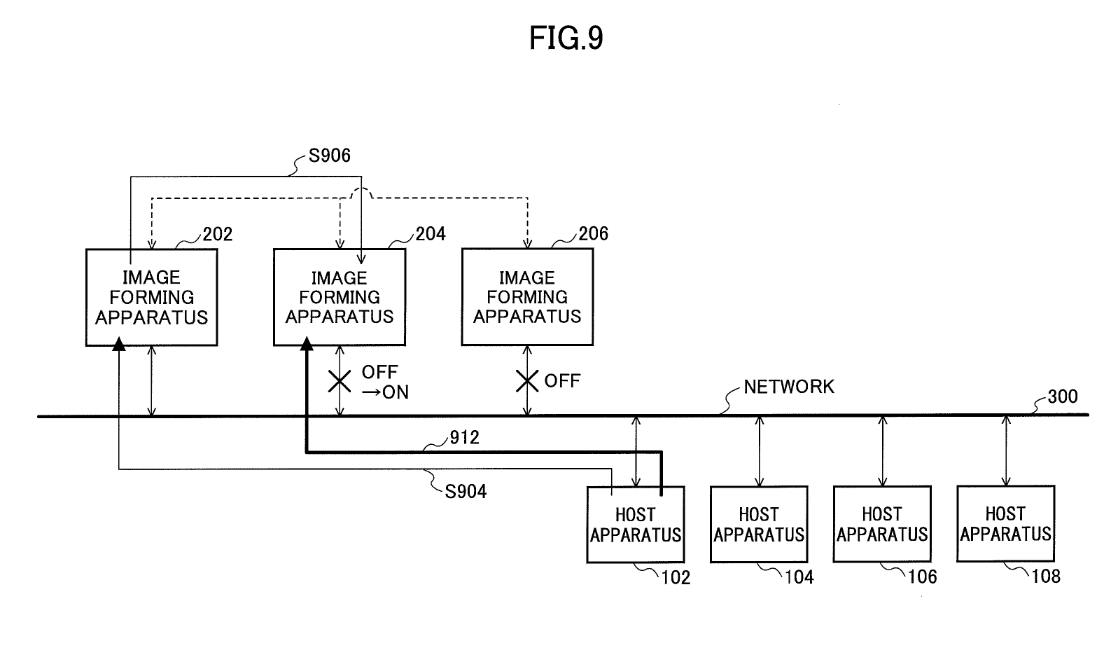

FIG. 9 shows the operation of the modified embodiment of the communication system. The image forming apparatuses 202, 204 and 206, and the host apparatuses 102, 104, 106 and 108 are shown in FIG. 9.

The image forming apparatuses 204 and 206 are in the shutdown mode (S4).

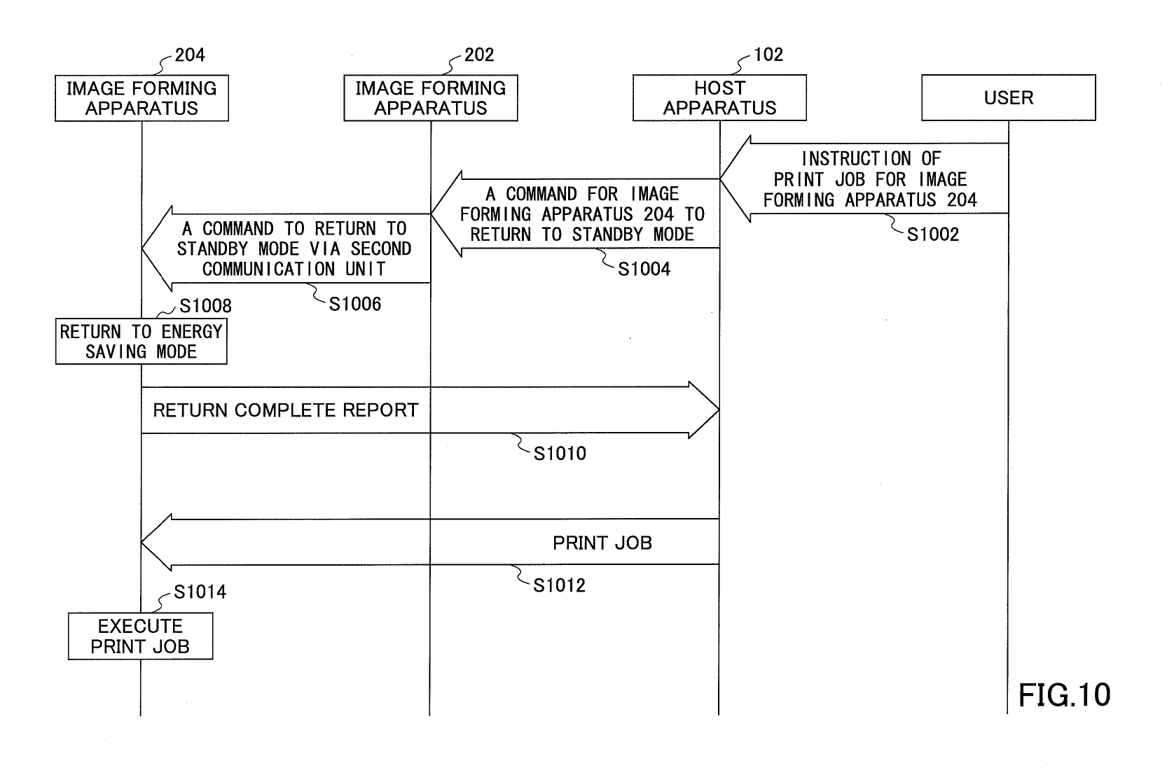

FIG. 10 is a sequence chart illustrating the operation of the modified embodiment of the communication system.

FIG. 10 shows the operation in the case of using the image forming apparatus 204, whose responding-through-network function is OFF, for a print job.

Steps of S904, S906 and S912 shown in FIG. 9 correspond to steps of S1004, S1006 and S1012 in FIG. 10, respectively.

The image forming apparatuses 204 and 206, whose responding-through-network functions are OFF, report information about themselves to the image forming apparatus 202. The image forming apparatus 202 transmits the information reported by the image forming apparatuses 204 and 206 to the host apparatuses 102, 104, 106 and 108. In the host apparatuses 102, 104, 106 and 108, the information about the image forming apparatuses 204 and 206 is interpreted by the installed printer driver. The host apparatuses 102, 104, 106 and 108 can recognize existence of the sub-apparatus image forming apparatuses 204 and 206 whose responding-through-network functions are OFF.

The modified embodiment of the GUI for selecting an image forming apparatus for a print job presented by the host apparatuses 102, 104, 106 and 108 is about the same as shown in FIG. 8.

In step S1002, a print job instruction is performed by a user. For example, when the user wants to perform a print job using the image forming apparatus 204, whose responding-through-network function is OFF, the user selects “Printer2” by using the GUI shown in FIG. 8. The print job is input to the host apparatus 102 by the user's operation.

In step S1004, the host apparatus 102, to which the print job is input by the user, transmits a command for causing the image forming apparatus 204 to return to the standby mode (S1) to the image forming apparatus 202.

In step S1006, the image forming apparatus 202 transmits a command for returning to the standby mode (S1) to the image forming apparatus 204 via the second communication unit 306.

In step S1008, the image forming apparatus 204, which has received the command for returning to the standby mode (S1) from the image forming apparatus 202, moves from the shutdown mode (S4) to the standby mode (S1).

In step S1010, the image forming apparatus 204, after moving to the standby mode (S1), transmits a return-complete report to the host apparatus 102.

In step S1012, the host apparatus 102, which has received the return-complete report from the image forming apparatus 204, transmits the print job to the image forming apparatus 204.

In step S1014, the image forming apparatus 204 executes the print job from the host apparatus 102.

In step S1010 in the sequence chart shown in FIG. 10, the return-complete report may be transmitted to the host apparatus 102 from the image forming apparatus 204 via the image forming apparatus 202.

According to the modified embodiment of the communication system, the same as the above embodiment, in an environment where multiple image forming apparatuses are placed and connected through a network, the responding-through-network functions can be set either ON or OFF in accordance with the situation of how each of the image forming apparatuses is used. Because the responding-through-network function can be set either ON or OFF for each of the image forming apparatuses, the power that is necessary for communication through the network can be reduced. Furthermore, the main-apparatus image forming apparatus reports to the host apparatuses information about the image forming apparatuses whose responding-through-network functions are OFF. With the information about the image forming apparatuses whose responding-through-network functions are OFF being reported by the main-apparatus image forming apparatus, the host apparatuses can recognize the image forming apparatuses whose responding-through-network functions are OFF. Furthermore, the host apparatuses can transmit a command to the image forming apparatuses whose responding-through-network functions are OFF.

Also, in accordance with the command from the host apparatus for the image forming apparatus, whose responding-through-network function is OFF, the main-apparatus image forming apparatus can cause the image forming apparatus, whose responding-through-network function is OFF, to return to the standby mode (S1) and to execute the command.

### Modified Embodiment (No. 2)

The modified embodiment of the communication system is about the same as the above embodiment.

The modified embodiment of the image forming apparatuses 202, 204 and 206 is about the same as the above embodiment.

<Operation of the Communication System>

The operation of the modified embodiment of the communication system is about the same as shown in FIG. 9.

The image forming apparatuses 204 and 206 are in the shutdown mode (S4).

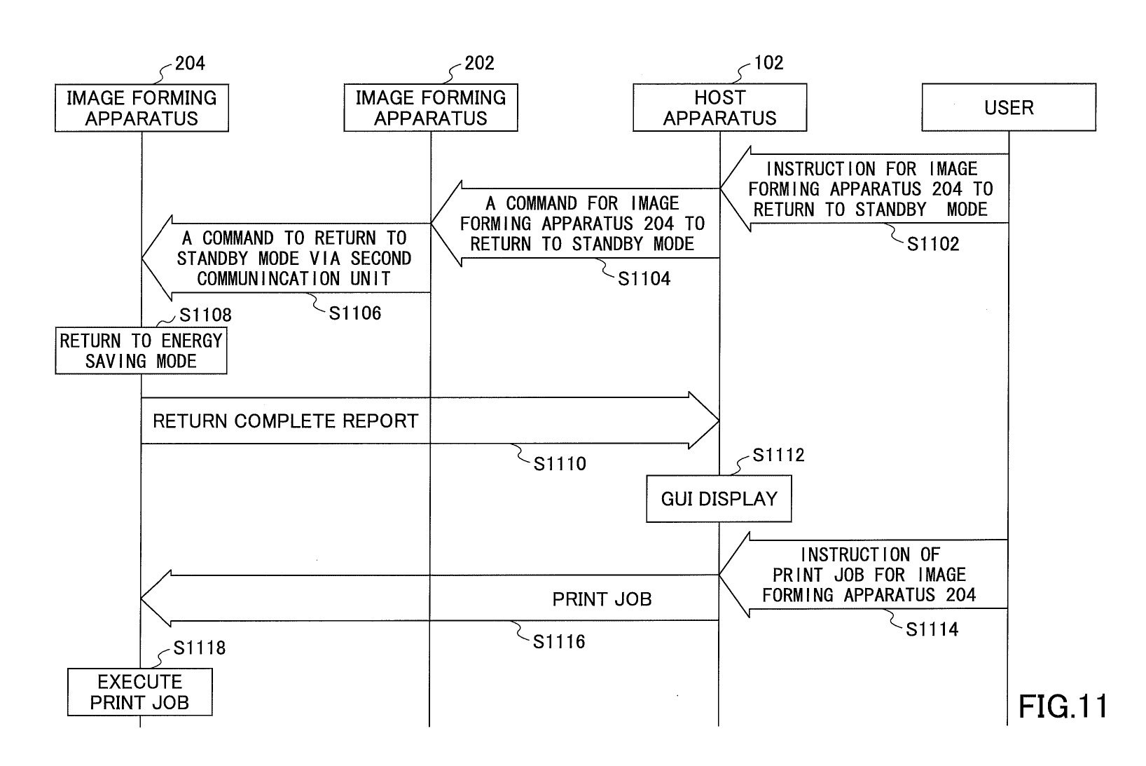

FIG. 11 is a sequence chart illustrating the operation of the modified embodiment of the communication system.

FIG. 11 shows the operation in the case of using the image forming apparatus 204, whose responding-through-network function is OFF, for a print job.

The image forming apparatuses 204 and 206, whose responding-through-network functions are OFF, report information about themselves to the image forming apparatus 202. The image forming apparatus 202 transmits the information reported by the image forming apparatuses 204 and 206 to the host apparatuses 102, 104, 106 and 108. In the host apparatuses 102, 104, 106 and 108, the information about the image forming apparatuses 204 and 206 is interpreted by the installed printer driver. The host apparatuses 102, 104, 106 and 108 can recognize existence of the sub-apparatus image forming apparatuses 204 and 206 whose responding-through-network functions are OFF.

The modified embodiment of the GUI for selecting an image forming apparatus for a print job presented by the host apparatuses 102, 104, 106 and 108 is about the same as shown in FIG. 8.

In step S1102, an instruction for returning to the standby mode (S1) is indicated by a user. For example, in the case where the user wants to perform a print job using the image forming apparatus 204, the user selects “Printer2” by using the GUI shown in FIG. 8. The instruction for returning to the standby mode (S1) is input to the host apparatus 102 by the user's operation.

In step S1104, the host apparatus 102, to which the instruction for returning to the standby mode (S1) is input by the user, transmits to the image forming apparatus 202 a command for the image forming apparatus 204 to return to the standby mode (S1).

In step S1106, the image forming apparatus 202 transmits the command for returning to the standby mode (S1) to the image forming apparatus 204 via the second communication unit 306.

In step S1108, the image forming apparatus 204, which has received the command to return to the standby mode (S1) from the image forming apparatus 202, moves from the shutdown mode (S4) to the standby mode (S1).

In step S1110, the image forming apparatus 204, after moving to the standby mode (S1), transmits a return-complete report to the host apparatus 102.

In step S1112, the host apparatus 102, which has received the return-complete report from the image forming apparatus 204, presents a GUI. For example, in the GUI shown in FIG. 8, in order to indicate that the image forming apparatus 204 becomes an operation target, it is preferable that the picture of the image forming apparatus 204 is displayed in the same bright color as the image forming apparatus 202.

In step S1114, the print job instruction is indicated by the user. For example, in the case where the user wants to have the print job executed by the image forming apparatus 204, which has returned to the mode in which the responding-through-network function is ON, the user selects “Printer2” by using the GUI shown in FIG. 8. The print job instruction is input to the host apparatus 102 by the user's operation.

In step S1116, the host apparatus 102, to which the print job instruction is input by the user, transmits the print job to the image forming apparatus 204.

In step S1118, the image forming apparatus 204 executes the print job from the host apparatus 102.

According to the modified embodiment of the communication system, the same as the above embodiment, in an environment where multiple image forming apparatuses are placed and connected through a network, the responding-through-network functions can be set either ON or OFF in accordance with the situation of how each of the image forming apparatuses is used. Because the responding-through-network function can be set either ON or OFF for each of the image forming apparatuses, the power that is necessary for communication through the network can be reduced. Furthermore, the main-apparatus image forming apparatus reports to the host apparatuses information about the image forming apparatuses whose responding-through-network functions are OFF. With the information about the image forming apparatuses whose responding-through-network functions are OFF being reported by the main-apparatus image forming apparatus, the host apparatuses can recognize the image forming apparatuses whose responding-through-network functions are OFF. Furthermore, the host apparatuses can transmit a command to the image forming apparatuses whose responding-through-network functions are OFF.

Also, in accordance with the command from the host apparatus for the image forming apparatus, whose responding-through-network function is OFF, the main-apparatus image forming apparatus can cause the image forming apparatus, whose responding-through-network function is OFF, to return to the standby mode (S1) and to execute the command.

Furthermore, the user can activate the image forming apparatus, whose responding-through-network function is OFF, without going to the place where the apparatus is placed.

### Modified Embodiment (No. 3)

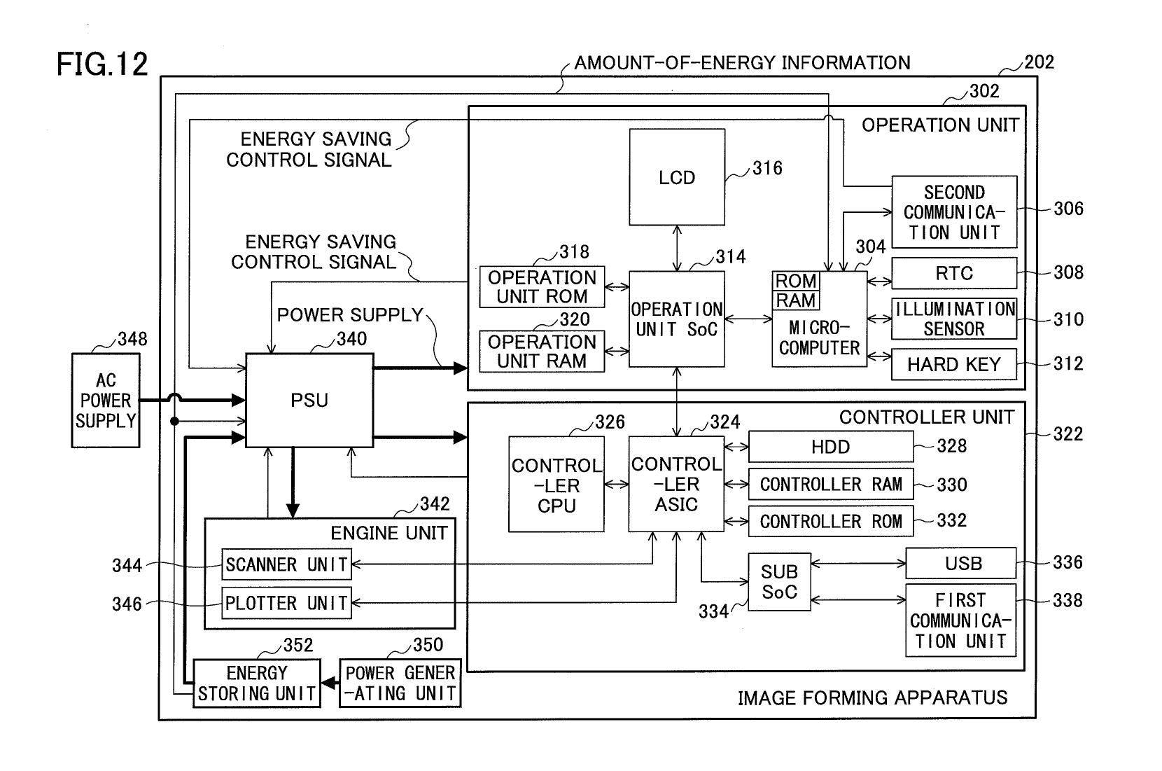

FIG. 12 shows a modified embodiment of the image forming apparatus 202. The image forming apparatuses 204 and 206 are about the same as shown in FIG. 12.

The modified embodiment of the image forming apparatuses 202, 204 and 206 is an image forming apparatus that includes the image forming apparatus 202 described by referring to FIG. 3 and further includes an energy storing unit 352 and a power generating unit 350.

The power generating unit 350 includes a function to generate power. For example, it is preferable that the power generating unit 350 be configured to include a device, which generates power from natural energy, such as a solar battery, a thermoelectric transducer, etc. The power generating unit 350 stores generated energy in the energy storing unit 352.

The energy storing unit 352 stores the energy from the power generating unit 350.

The PSU 340 switches the power supply for supplying power to the operation unit 302, the controller unit 322 and the engine unit 342, switching between the AC power supply 348 and the energy storing unit 352 in accordance with the amount of energy stored in the energy storing unit 352.

The amount of energy stored in the energy storing unit 352 of the image forming apparatuses 204 and 206 is reported to the image forming apparatus 202 by using the second communication unit 306 via the microcomputer 304. For example, it is preferable that the image forming apparatus 204 or 206, which is in the shutdown mode, report the amount of energy stored in the energy storing unit 352 to the image forming apparatus 202 by using the second communication unit 306 periodically or non-periodically. By this, the image forming apparatus 202 can monitor the amount of energy stored in the image forming apparatus 204 or 206, which is in the shutdown mode.

In the case where there are multiple sub-apparatus image forming apparatuses, the main-apparatus image forming apparatus may determine the sub-apparatus image forming apparatuses that should return from the shutdown mode (S4) only after knowing the amount of energy stored in the multiple sub-apparatus image forming apparatuses. When the main-apparatus image forming apparatus determines the sub-apparatus image forming apparatuses that should return from the shutdown mode (S4), it is preferable that the main-apparatus image forming apparatus preferentially cause those sub-apparatus image forming apparatuses to return from the shutdown mode (S4) that store more than predefined amount of energy and can operate without using AC power supply. By doing this, usage of AC power supply 348 can be reduced.

<Operation of the Communication System>

The modified embodiment (No. 3) of the operation of the communication system is about the same as the above embodiment, the modified embodiment (No. 1) and the modified embodiment (No. 2).

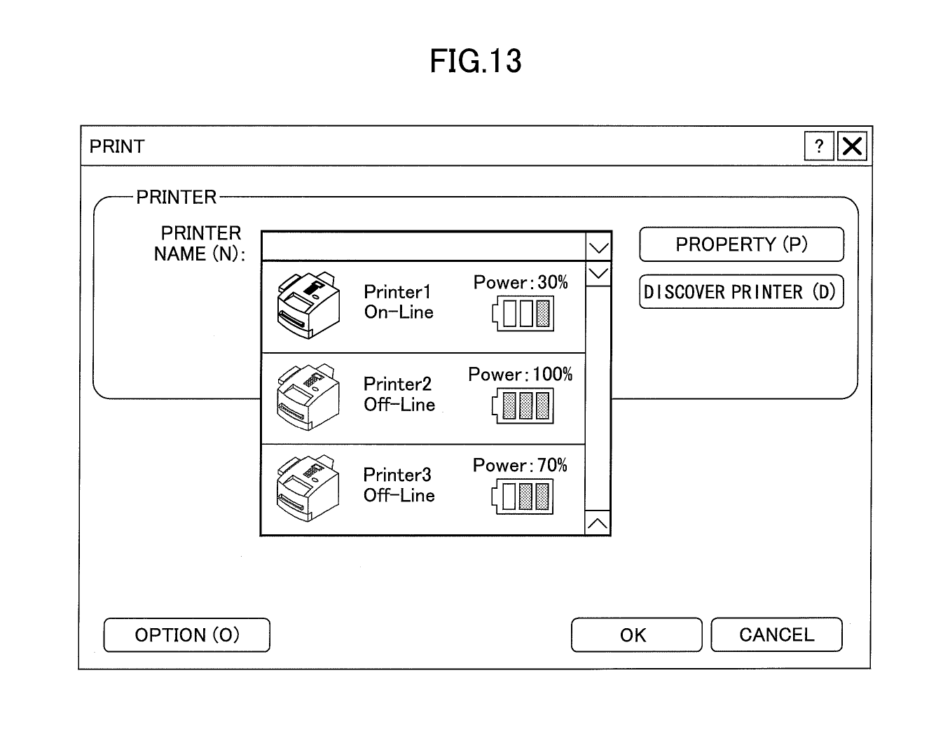

FIG. 13 illustrates an embodiment of the GUI in the host apparatuses 102, 104, 106 and 108 for selecting the image forming apparatus for the print job.

The modified embodiment of the GUI is the GUI described referring to FIG. 8 that can further display the amount of energy stored in each of the image forming apparatuses. In an example shown in FIG. 13, the amount of energy stored in each of the image forming apparatuses is indicated in the percentage form and is also indicated by three bars.

As described above, the image forming apparatus 202 obtains the amount of energy stored in each of the image forming apparatuses 204 and 206 by using the second communication unit 306 and reports it to the host apparatuses 102, 104, 106 and 108.

In the host apparatuses 102, 104, 106 and 108, the installed printer driver interprets the amount of energy stored in each of the image forming apparatuses 204 and 206. In the host apparatuses 102, 104, 106 and 108, the amount of energy stored in each of the image forming apparatuses 204 and 206 is reported to the user by the GUI. By doing this, the user can be prompted to perform the print job by preferentially using the image forming apparatus that stores more energy than others.

According to the modified embodiment of the communication system, the same as the above embodiment, in an environment where multiple image forming apparatuses are placed and connected through a network, the responding-through-network functions can be set either ON or OFF in accordance with the situation of how each of the image forming apparatuses is used. Because the responding-through-network function can be set either ON or OFF for each of the image forming apparatuses, the energy that is necessary for communication through the network can be reduced. Furthermore, the main-apparatus image forming apparatus reports to the host apparatuses information about the image forming apparatuses whose responding-through-network functions are OFF. With the information about the image forming apparatuses whose responding-through-network functions are OFF being reported by the main-apparatus image forming apparatus, the host apparatuses can recognize the image forming apparatuses whose responding-through-network functions are OFF. Furthermore, the host apparatuses can transmit a command to the image forming apparatuses whose responding-through-network functions are OFF.

Also, in accordance with the command from the host apparatus for the image forming apparatus, whose responding-through-network function is OFF, the main-apparatus image forming apparatus can cause the image forming apparatus, whose responding-through-network function is OFF, to return to the standby mode (S1) and to execute the command.

Furthermore, by reporting the amount of energy stored in each of the image forming apparatuses to the user, the user can be prompted to perform the print job by preferentially using the image forming apparatus that stores more energy than others.

For the sake of convenience, the apparatuses according to the embodiments of the present invention are described by using functional block diagrams. These apparatuses may be implemented by hardware or software or a combination of both. Further, the present invention is not limited to these embodiments, and various variations and modifications may be made without departing from the scope of the present invention.

The present application is based on and claims the benefit of priority of Japanese Priority Application No. 2012-252930 filed on Nov. 19, 2012, with the Japanese Patent Office, the entire contents of which are hereby incorporated by reference.

What is claimed is:

1. A communication system comprising:
a plurality of communication apparatuses and
a host apparatus connected to the plurality of the communication apparatuses through a network,
the plurality of the communication apparatuses including a first communication apparatus and a second communication apparatus,
the first communication apparatus including:
a first communication unit for communicating with the host apparatus through the network;
a second communication unit for communicating with the second communication apparatus that has moved to a state in which the second communication apparatus cannot communicate through the network; and
an apparatus information obtaining unit for obtaining information about the second communication apparatus that has moved to the state in which the second communication apparatus cannot communicate through the network by using the second communication unit, wherein
the first communication unit reports to the host apparatus the information about the second communication apparatus obtained by the apparatus information obtaining unit, and
the host apparatus accepts from a user a first command for the second communication apparatus based on the information about the second communication apparatus reported by the first communication unit of the first communication apparatus.

2. The communication system as claimed in claim 1, wherein the first communication apparatus further includes a state control unit for performing control of, in accordance with the first command from the host apparatus for the second communication apparatus that has moved to the state in which the second communication apparatus cannot communicate through the network, causing the second communication apparatus to move to a state in which the first command can be executed, and the second communication apparatus includes a state transition processing unit for, due to the control performed by the state control unit, performing a process of moving to the state in which the first command can be executed.

3. The communication system as claimed in claim 2, wherein the state control unit, using the second communication unit, performs control of transmitting a second command for causing the second communication apparatus to move to the state in which the first command can be executed,
wherein the state transition processing unit, in accordance with the second command, performs a process of moving to the state in which the first command can be executed, and
wherein the state control unit, after the second communication apparatus moves to the state in which the first command can be executed, performs a control of transmitting the first command using the first communication unit or the second communication unit.

4. The communication system as claimed in claim 1, wherein the host apparatus accepts from the user a third command for the second communication apparatus,
wherein the first communication apparatus includes a state control unit for performing control of, in accordance with the third command from the host apparatus for the second communication apparatus that has moved to the state in which the second communication apparatus cannot communicate through the network, causing the second communication apparatus to move to a state in which the first command can be executed,
wherein the second communication apparatus includes a state transition processing unit for, due to the control performed by the state control unit, performing a process of moving to the state in which the first command can be executed,
wherein the state control unit, using the second communication unit, performs control of transmitting the third command for causing the second communication apparatus to move to the state in which the first command can be executed, and
wherein the state transition processing unit, in accordance with the third command, performs a process of moving to the state in which the first command can be executed.

5. The communication system as claimed in claim 2, wherein the state transition processing unit performs control of reporting to the host apparatus that the second communication apparatus has moved to the state in which the first command can be executed, and
wherein the host apparatus presents to the user that the second communication apparatus has moved to the state in which the first command can be executed.

6. The communication system as claimed in claim 1, wherein each of the plurality of the communication apparatuses includes a power generating unit for generating power and an energy storing unit for storing energy generated by the power generating unit.

7. The communication system as claimed in claim 6, wherein an apparatus information obtaining unit, by using the second communication unit, obtains information indicating an amount of energy stored in the second communication apparatus,
wherein the first communication unit reports the amount of energy stored in the second communication apparatus obtained by the apparatus information obtaining unit to the host apparatus, and
wherein the host apparatus presents to the user the amount of energy stored in the second communication apparatus.

8. The communication system as claimed in claim 1, wherein the second communication unit includes a Zigbee, a Bluetooth, a wired communication or an infrared communication.

9. A communication apparatus in a communication system that includes a plurality of the communication apparatuses and a host apparatus connected to the plurality of the communication apparatuses through a network, the communication apparatus comprising:
a first communication unit configured to communicate with the host apparatus through the network,
a second communication unit configured to communicate with other communication apparatuses that have moved to a state in which the other communication apparatuses cannot communicate through the network, and
an apparatus information obtaining unit configured to obtain information about the other communication apparatuses by using the second communication unit, wherein the first communication unit reports to the host apparatus the information about the other communication apparatuses obtained by the apparatus information obtaining unit.

10. A communication method in a communication system that includes a plurality of the communication apparatuses and a host apparatus connected to the plurality of the communication apparatuses through a network, the plurality of the communication apparatuses including a first communication apparatus and a second communication apparatus, the communication method comprising:
an apparatus information obtaining step of obtaining information about the second communication apparatus by the first communication apparatus by using a second communication unit that performs communication with the second communication apparatus that has moved to a state in which the second communication apparatus cannot communicate through the network;
an apparatus information reporting step of reporting to the host apparatus the information about the second communication apparatus obtained in the apparatus information obtaining step by using a first communication unit of the first communication apparatus that performs communication through the network; and
a step of accepting a first command for the second communication apparatus from a user by the host apparatus based on information about the second communication apparatus reported by the first communication unit of the first communication apparatus.
